(19) United States
(12) Patent Application Publication
(10) Pub. No.: US 2015/0059538 A1
(43) Pub. Date: Mar. 5, 2015

(54) SCREW GRABBER

(71) Applicant: Phillip Kauffman, Perris, CA (US)

(72) Inventor: Phillip Kauffman, Perris, CA (US)

(21) Appl. No.: 14/465,889

(22) Filed: Aug. 22, 2014

Related U.S. Application Data
(60) Provisional application No. 61/872,318, filed on Aug. 30, 2013.

(51) Int. Cl. B25B 23/10

(52) U.S. Cl. CPC B25B 23/101
USPC 81/452; 81/451

(57) ABSTRACT

The present device is a fastener holder providing a range of accommodation for different sizes of fasteners and screwdrivers. The novel concept involves a tapered and slotted wall at one end of a tubular sleeve, and a ribbed grip at the other end, to minimize the sleeve profile while providing size flexibility and improved grip on work pieces.

### CROSS-REFERENCE TO RELATED APPLICATIONS

This is a U.S. Non-Provisional Patent Application claiming priority to U.S. Provisional Patent Application 61/872,318, filed Aug. 30, 2013, which is incorporated by reference herein in entirety.

### FIELD OF THE INVENTION

This invention relates to fastener holding systems, and more particularly to a fastener retainer for a screwdriver.

### BACKGROUND OF THE INVENTION

Unless two hands are employed, a device is needed to hold a screw and a screwdriver together when positioning it relative to a screw hole or a receiving location. In certain circumstances, space restrictions prevent the use of an assisting hand. In other circumstances, precision placement requires the dexterity of a single, guiding hand. In all circumstances, a freed hand is a benefit.

The prior art is replete with screw-holding mechanisms. In the simplest form, a magnetic-tipped screwdriver attracts the screw. The disadvantage with a magnet, however, is that it only works with ferrous-type fasteners, leaving the field of non-ferrous fasteners unserved. Additionally, the magnet commonly picks up stray metal filings and other metallic debris that may be in the work zone. Lastly, it is unusable around electrical circuits and in magnetically-sensitive environments.

Other mechanisms include the clip-type and the tube-type of driver-screw holders. In the former case, a clip attached to a screwdriver is used to releasably clamp a screw in its throat. This arrangement permits little accommodation for different sizes of screw gauges, not to mention sizes of driver shanks With the tube-type of holder, the screw head is positioned in one end of a tube while the driver shank is sleeved through the other end. In making accommodation to release different-sized screw heads, this type of holder requires a bulbous envelope of surrounding space making it difficult, as a consequence, to use the device in tight spaces. Moreover, because of the frictional resistance involved in inserting the screwdriver shank into a tightly-fitting sleeve, the grip on the screwdriver is often compromised in tradeoff. This places the loss of precision guidance in tension with any flexibility afforded for different size screwdrivers.

There is an unfilled need in the present state of art to accommodate both different sizes of screws and screwdrivers while, at the same time, retaining a relatively narrow profile and additionally providing grip integrity.

### SUMMARY OF THE INVENTION

The present invention addresses this unfilled need in a novel tubular holder featuring a feathered screw-holding end opposite a ribbed shank-holding end.

It is an object of the present invention, therefore, to hold a screw and its driver together for positioning purposes. It is a further object to accommodate different sizes of screws and screwdrivers in the same device. It is a further object to make the sizing accommodations in a diminutive tubular profile. It is a further object to minimize any expansion of, and therefore clearance for, the tube end when releasing the held screw. It is a further object to reduce the resistance to inserting a screwdriver shank into a device without compromise to a firm grip on the shank. It is a further object to accomplish the above objects as inexpensively and operationally-intuitive as possible.

These objects, and others to become hereinafter apparent, are embodied in a fastener holder for a screwdriver comprising a tube having a profile of substantially narrow girth, a resiliently-pliable wall, a cylindrical space there through, and a proximal end and a distal end thereto. The proximal end is configured to releaseably receive a fastener head to a medial point of the tube. The distal end is configured to frictionally receive a shank of the screwdriver to at least the medial point. The fastener holder further comprises a means for accommodating different size screwdriver shanks; and, additionally, a means for accommodating different size fastener heads. The profile of the tube is configured to fit tight spaces, while the resiliently-pliable wall provides gripping tension. Flexibility of application is afforded by the means for accommodating differing sizes of both screwdriver shanks and fastener heads.

In the preferred embodiment, the means for accommodating different size screwdriver shanks comprises longitudinal ribs debossed on the resiliently-pliable wall in the cylindrical space extending from the distal end to a medial point in the tube. Further, the means for accommodating different size fastener heads comprises a combination of features. The first feature involves a tapering in the thickness of the resiliently-pliable wall from the medial point to the proximal end such that the cylindrical space broadens toward the proximal end in correspondence to the tapering. The second feature involves at least one longitudinal slit at the proximal end extending to the medial point. The at least one longitudinal slit, and, more preferably, two or more such slits, enables the proximal end to flare open for receiving and releasing the fastener head.

In a particular preferred embodiment, the tapered, resiliently-pliable wall comprises transverse rings embossed therein, each ring having a different diameter according to the tapering, with adjacent rings separated by debossed ribs. The debossed ribs underlap an inserted screw head and function to hold it in place.

As this is not intended to be an exhaustive recitation, other embodiments may be learned from practicing the invention or may otherwise become apparent to those skilled in the art.

### DESCRIPTION OF THE DRAWINGS

Various other objects, features and attendant advantages of the present invention will become fully appreciated as the same becomes better understood through the accompanying drawings and the following detailed description, in which like reference characters designate the same or similar parts throughout the several views, and wherein:

FIG. 1 is a perspective view of the invention holding a screwdriver and a screw, shown in broken line, as work pieces;

FIG. 2 is a bottom plan view of FIG. 1 showing the sectional cut line 3-3;

FIG. 3 is a section view taken along the line 3-3 of FIG. 2;

FIG. 4 is a diagram showing a flare angle;

FIG. 5 is another bottom plan view of FIG. 1 showing the sectional cut line 6-6;

FIG. 6 is a sectional view taken along the line 6-6 of FIG. 5;

FIG. 7 is a perspective view of the invention;

FIG. 8 is a bottom plan view of FIG. 7 showing the sectional cut line 9-9;

FIG. 9 is a section view taken along the line 9-9 of FIG. 8;

FIG. 10 is a diagram of a taper angle; and

FIG. 11 is top plan view of FIG. 7.

### DETAILED DESCRIPTION OF THE PREFERRED EMBODIMENT

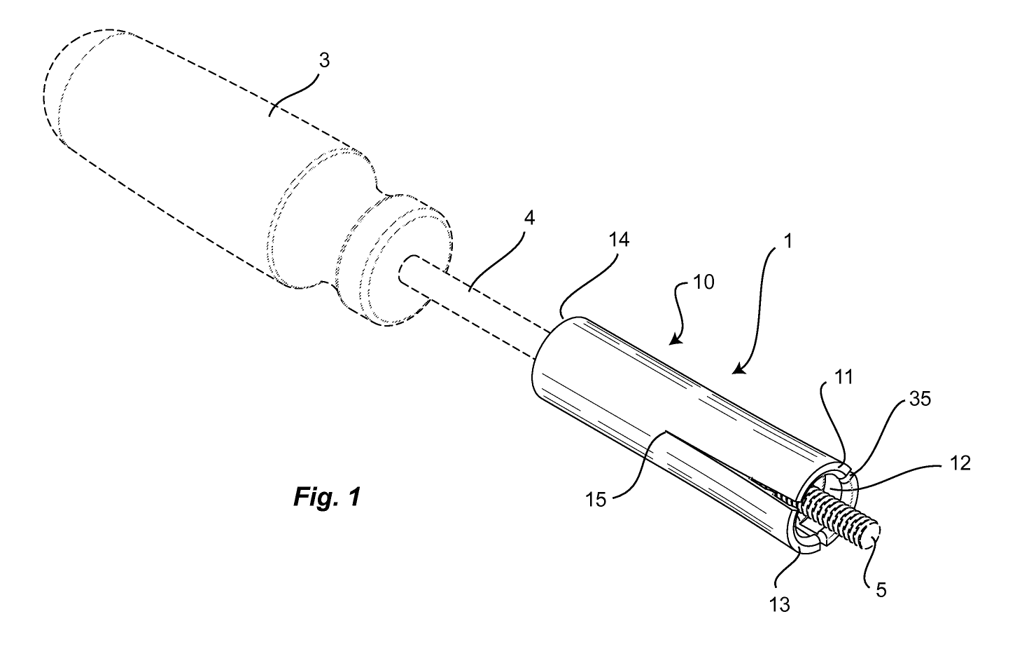

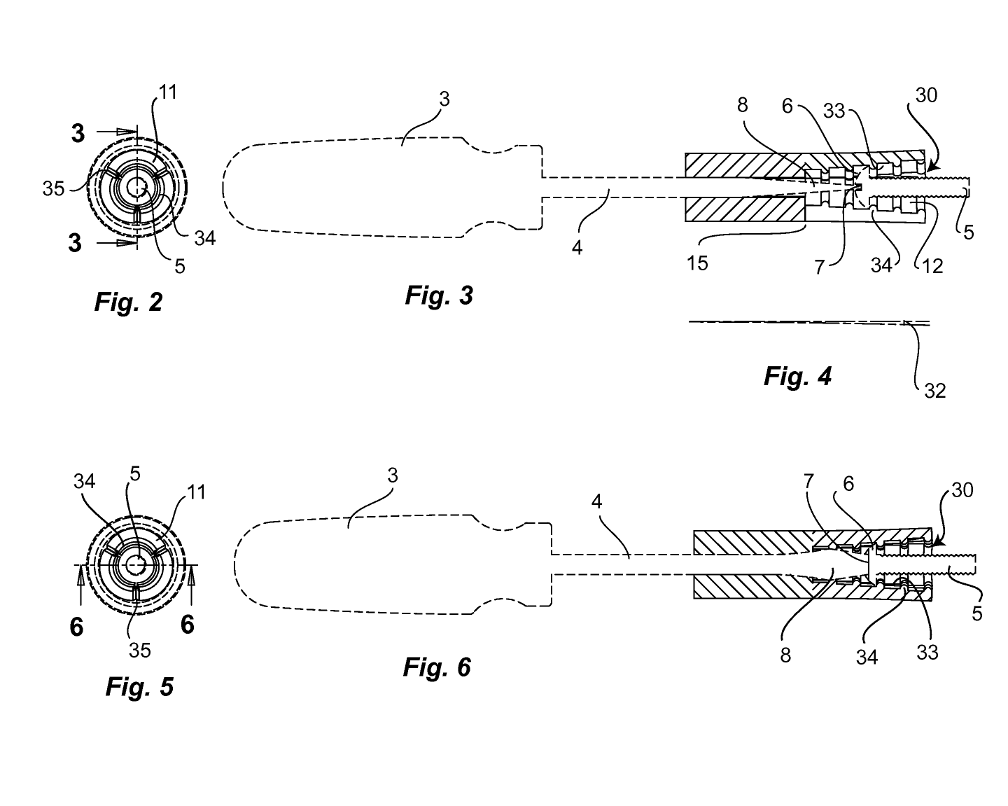

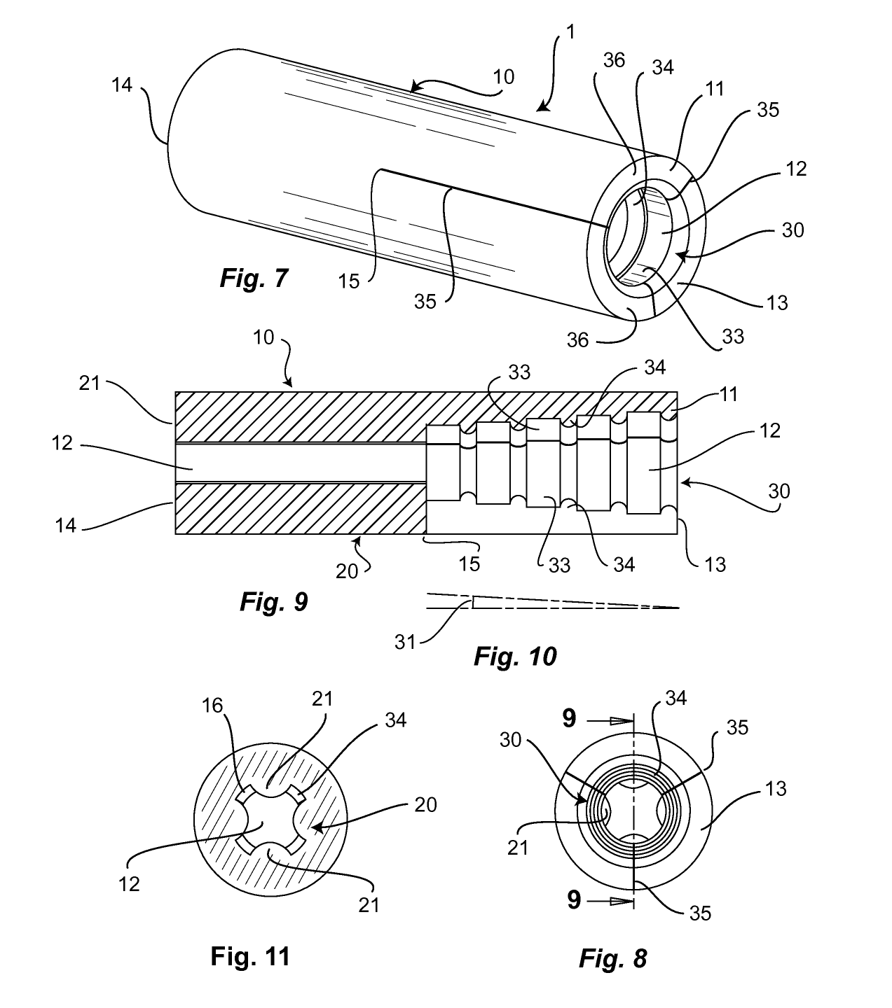

As best shown in FIGS. 7, 9 and 11, a fastener holder 1 for a screwdriver 3 and a screw 5 (see FIG. 1) is comprised of a tube 10 having a resiliently-pliable wall 11 and a cylindrical space 12 there through. The tube 10 has a proximal end 13 and a distal end 14. The proximal end 13 receives a screw head 6 of the screw 5 and the distal end 14 receives a shank 4 of the screwdriver 3 into the cylindrical space 12 (see FIGS. 3 and 6). The shank 4 and the screw head 6 are generally, but not exclusively, of circular cross-section. The screwdriver 3 has a screwdriver tip 8 at a distal end of the shank 4, which may be of blade design, as shown in FIGS. 3 and 6; or, may, otherwise, be of phillips-head, allen-head, or another design. The screw head 6 has a screw head slot 7, which is complementary to a preferred screwdriver tip 8. The invention comprehends different mating designs of fasteners and drivers, as well as fasteners other than screws.

As shown in FIGS. 8, 9 and 11, the fastener holder 1 also comprises a means for accommodating different size shanks 20. In the preferred embodiment, the means for accommodating 20 comprises longitudinal ribs 21 debossed onto the resiliently-pliable wall 11 and standing proud in the cylindrical space 12. The longitudinal ribs 21 extend from the distal end 14 to at least a medial point 15 on the tube 10. Being of the same is material as the resiliently-pliable wall 11, the longitudinal ribs 21 can be compressed to accommodate different sizes of shanks 4 Interstitial spaces 16 between the longitudinal ribs 21 provide lateral space for compression and also provide clearance for the widened tip end of the blade design of screwdriver. In an alternate embodiment, the means for accommodating different size shanks 20 are transverse ribs (not shown). Preferably, the longitudinal ribs 21 number four. At least three ribs, nevertheless, should be used to maintain to maintain concentricity. The longitudinal ribs 21 provide a gripping force on the screwdriver shank 4 by compression means, but also limit the contact surface at the interface by diverging contour means. The limited contact area reduces the frictional resistance during insertion of the shank 4 without compromise to the holding grip.

As shown in FIGS. 3, 6, 9 and 10, the fastener holder 1 further comprises a means for accommodating different size fastener heads 30. In the preferred embodiment, the means for accommodating 30 includes a tapering of the resiliently-pliable wall 11. A taper 31, shown as an angle in FIG. 10, is such as to progressively broaden the cylindrical space 12 toward the proximal end 13. The taper 31 extends from the medial point 15 feathering the wall to the proximal end. Rings 33 are embossed in the wall 11 in progressively widening diameters following the taper 31. Adjacent rings 33 are separated by proud transverse ribs 34. The transverse ribs 34, also being of resiliently-pliable construction, permit the screw head 6 to bypass and to seat thereupon by underlap means for holding purposes. The taper 31 permits unique seating for different size screw heads according to the diameter progression of the ribs 34. In an alternate embodiment, the transverse ribs 34 are replaced by transverse notches in the wall (not shown).

The means for accommodating 30 additionally includes longitudinal slits 35 (see FIG. 7). The longitudinal slits 35 extend from the proximal end 13 to the medial point 15 and essentially divide the section of the tube 10 there between into lobes 36. The lobes 36 can flex outwardly in a flare 32 of the proximal end 13, as shown as an angle in FIG. 4.

The flare 32 provides additional accommodation for screw head sizing by expanding the rings 33. The taper 31, by means of wall thickness reduction, makes the bending modulus a function of the distance from the proximal end. In this way, the bend of the flare 32 is progressively moved toward the proximal end, which has the result of minimizing the flare. Thus, the combination of the flare 32 and the taper 31 reduce the profile of the tube 10 when engaging, and more particularly, when releasing, the screw head. Additionally, an unexpected beneficial result affecting the release of the screw 5 is made possible by the taper 31. The larger-headed screws, because of size, share more contact surface with the transverse ribs 34. This would normally make bypass more difficult. The larger-headed screws, however, are positioned closer to the proximal end 13, where the taper 31 reduces the force to flex the wall away and negates any effect due to size. The preferred number of longitudinal slits 35 is three, but any number of slits can be used to effect.

The fastener holder 1 is preferably injected molded with a silicone resin or another thermoplastic elastomer. It can also be fabricated by machining from a rubber block, or compression molded in halves from rubber sheet material. Preferably, the material is is transparent so that the positioning and mating of the driver tip 8 and the screw head slot 7 can be visually inspected while under manipulation. The preferred length of the tube 10 is 0.75-1.5 inches; the preferred OD is 0.25-0.75 inches. The preferred taper 31 is 3-6 degrees, depending on wall thickness and positioning of the medial point 15.

A method of using the fastener holder 1 comprises the steps of inserting the screw 5 in the proximal end 13 of the tube 10; inserting the screwdriver shank 4 into the distal end 14; mating the screwdriver tip 8 with the screw head slot 7; positioning the screw 5 by means of the fastener holder 1 to align with a receiving location; turning the screwdriver 3 to seat the screw 5; and, sliding the tube 10 rearwardly away from the screw to release the screw by flaring the lobes 36.

It is to be understood that the invention is not limited in its application to the details of construction, to the arrangements of the components and to the method of using set forth in the preceding description or illustrated in the drawings. For example, the cylindrical space 12 may be of a different cross-section than circular. Also, it is to be understood that the phraseology and terminology employed herein are for the purpose of the description and should not be regarded as limiting.

What is claimed is:

1. A fastener holder for a screwdriver comprising:
a tube having a profile of substantially narrow girth, a resiliently-pliable wall, a cylindrical space there through, and a proximal end and a distal end thereto, the proximal end configured to releaseably receive a fastener head to a medial point of the tube, the distal end configured to frictionally receive a shank of the screwdriver to at least said medial point;
to a means for accommodating different size screwdriver shanks; and
a means for accommodating different size fastener heads;
whereby a profile of the tube fits into tight spaces, the resiliently-pliable wall provides gripping tension, and flexibility of application is afforded by the means for accommodating differing sizes of both screwdriver shanks and fastener heads.

2. The fastener holder of claim 1, wherein the means for accommodating different size screwdriver shanks comprises longitudinal ribs debossed onto the resiliently-pliable wall in the cylindrical space extending from the distal end to a medial point in the tube.

3. The fastener holder of claim 1, wherein the means for accommodating different size fastener heads comprises a tapering in thickness of the resiliently-pliable wall from the medial point to the proximal end such that the cylindrical space broadens toward the proximal end in correspondence to the tapering.

4. The fastener holder of claim 3, wherein the tapered resiliently-pliable wall comprises a multiplicity of transverse rings embossed there into, each ring having a different diameter according to the tapering, adjacent rings separated by debossed ribs functioning to hold the fastener heads by underlapping structure.

5. The fastener holder of clam 1, further comprising at least one longitudinal slit at the proximal end extending to the medial point, the at least one longitudinal slit enabling the proximal end to flare open for receiving and releasing the fastener head.

6. The fastener hold of claim 5, wherein the longitudinal slits number 2 and divide a proximal end portion of the tube into two equal lobes.

7. The fastener hold of claim 5, wherein the longitudinal slits number 3 and divide a is proximal end portion of the tube into three equal lobes.

8. The fastener holder of claim 1, wherein the resiliently pliable wall is transparent to enable visual interpositioning of a screwdriver tip and a slot in the fastener head.
